(19) United States
(12) Patent Application Publication
(10) Pub. No.: US 2026/0153982 A1
(43) Pub. Date: Jun. 4, 2026

(54) METHOD, APPARATUS, DEVICE AND STORAGE MEDIUM FOR INTERFACE INTERACTION

(71) Applicant: Beijing Zitiao Network Technology Co., Ltd., Beijing (CN)

(72) Inventors: Jiashu Liu, Beijing (CN); Xinyu Zhang, Beijing (CN); Lu Li, Beijing (CN); Lan Qi, Beijing (CN); Pingfangzi Ai, Beijing (CN); Weijian Chen, Beijing (CN); Yuan Zhang, Beijing (CN); Peng Wang, Beijing (CN)

(21) Appl. No.: 19/405,081

(22) Filed: Dec. 1, 2025

(30) Foreign Application Priority Data
Dec. 2, 2024 (WO) PCT/CN2024/136237

(51) Int. Cl. G06F 3/04847; G06F 3/0481

(52) U.S. Cl. CPC G06F 3/04847; G06F 3/0481

(57) ABSTRACT

Embodiments of the disclosure relates to method, apparatus, device and a storage medium for interface interaction. The method provided by the disclosure includes: presenting a plurality of media components in a target style in a target interface, the target style indicating that at least a portion of the plurality of media components is organized in a plurality of columns or rows; triggering a first media component to play a corresponding first media content; determining whether the first media component satisfies a switching condition, in response to determining that a display position of at least one media component satisfies a trigger condition; and triggering, in response to the first media component satisfying the switching condition, a second media component in the at least one media component to play a corresponding second media content. In this way, the embodiments of the present disclosure may improve the presentation efficiency of the media content.

### CROSS-REFERENCE

This application claims priority to Internation Application No. PCT/CN2024/136237, filed on Dec. 2, 2024 and entitled ‘METHOD, APPARATUS, DEVICE AND STORAGE MEDIUM FOR INTERFACE INTERACTION’, which is incorporated herein by reference in its entirety.

### FIELD

Example embodiments of the present disclosure generally relate to the field of computers, and in particular, to a method, apparatus and device, and a computer-readable storage medium for interface interaction.

### BACKGROUND

In recent years, with the development of the Internet, more and more users view media content on a network platform. In order to satisfy the viewing requirements of the user and improve the presentation efficiency of the media content, the network platform tends to present a plurality of media contents in the same interface. However, the playing mechanisms provided by the network platform for the presented media content may not satisfy the requirements of users.

### SUMMARY

In a first aspect of the present disclosure, method for interface interaction is provided, including: presenting a plurality of media components in a target style in a target interface, the target style indicating that at least a portion of the plurality of media components is organized in a plurality of columns or rows; triggering a first media component to play a corresponding first media content; determining whether the first media component satisfies a switching condition, in response to determining that a display position of at least one media component satisfies a trigger condition; and triggering, in response to the first media component satisfying the switching condition, a second media component in the at least one media component to play a corresponding second media content.

In a second aspect of the present disclosure, an apparatus for interface interaction is provided. The apparatus includes: a presenting module configured to present a plurality of media components in a target style in a target interface, the target style indicating that at least a portion of the plurality of media components is organized in a plurality of columns or rows; a first triggering module configured to trigger a first media component to play a corresponding first media content; a determining module configured to determine whether the first media component satisfies a switching condition, in response to determining that a display position of at least one media component satisfies a trigger condition; and a second triggering module configured to trigger, in response to the first media component satisfying the switching condition, a second media component in the at least one media component to play a corresponding second media content

In a third aspect of the present disclosure, an electronic device is provided. The device includes: at least one processing unit; and at least one memory coupled to the at least one processing unit and storing instructions for execution by the at least one processing unit, the instructions, when executed by the at least one processing unit, causing the electronic device to perform the method of the first aspect.

In a fourth aspect of the present disclosure, a computer-readable storage medium is provided. The computer-readable storage medium has a computer program stored thereon, the computer program being executable by a processor to implement the method of the first aspect.

It would be appreciated that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment capable of implementing some embodiments of the present disclosure;

FIGS. 2A-2D illustrate example interfaces according to some embodiments of the present disclosure;

FIGS. 3A-3B illustrate example interfaces according to some embodiments of the present disclosure;

FIG. 4 shows a flowchart of an example process of interface interaction according to some embodiments of the present disclosure;

FIG. 5 illustrates a schematic structural block diagram of an example apparatus for interface interaction according to some embodiments of the present disclosure; and

FIG. 6 illustrates a block diagram of an electronic device capable of implementing various embodiments of the present disclosure.

### DETAILED DESCRIPTION

Embodiments of the present disclosure would be described in more detail below with reference to the accompanying drawings. While certain embodiments of the present disclosure are shown in the accompanying drawings, it would be understood that the present disclosure may be implemented in various forms and would not be construed as limited to the embodiments set forth herein. Rather, these embodiments are provided for a more thorough and complete understanding of the present disclosure. It would be understood that the drawings and embodiments of the present disclosure are for example purposes only and are not intended to limit the scope of the present disclosure.

It would be noted that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms ‘including’ and the like would be understood to include ‘including but not limited to’. The term ‘based on’ would be understood as ‘based at least in part on’. The terms ‘one embodiment’ or ‘the embodiment’ would be understood as ‘at least one embodiment’. The term ‘some embodiments’would be understood as ‘at least some embodiments’. Other explicit and implicit definitions may also be included below. The terms ‘first,’ ‘second,’ and the like may refer to different or identical objects. Other explicit and implicit definitions may also be included below.

Embodiments of the present disclosure may relate to data of a user, obtaining and/or use of data, and the like. These aspects all follow the corresponding laws and regulations and related regulations. In the embodiments of the present disclosure, all data collection, acquisition, processing, handling, processing, reposting, use, and the like are carried out on the premise of the knowledge and confirmation of the user. Accordingly, when implementing the embodiments of the present disclosure, the types of the data or information that may be involved, the usage scope, the usage scenario, and the like would be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function and may not affect the basic function of the user.

As briefly mentioned above, with the development of the Internet, more and more users view media content on a network platform. In order to satisfy the viewing requirements of the user and improve the presentation efficiency of the media content, the network platform tends to present a plurality of media contents in the same interface. For example, a plurality of media contents is presented in a plurality of rows or columns. While presenting the plurality of media content, the network platform needs to play the corresponding media content to satisfy the viewing requirements of the user. However, when the network platform plays the presented a plurality of media contents, the playing mechanism is too single (for example, only one-sided media content may be triggered to be played), which may not satisfy the user's needs.

Embodiments of the present disclosure provide a solution for interface interaction. According to the scheme, a plurality of media components are presented in a target style in a target interface, the target style indicating that at least a portion of the plurality of media components is organized in a plurality of columns or rows; a first media component is triggered to play a corresponding first media content; whether the first media component satisfies a switching condition is determined, in response to determining that a display position of at least one media component satisfies a trigger condition; and a second media component is triggered in the at least one media component to play a corresponding second media content in response to the first media component satisfying the switching condition.

In this manner, embodiments of the present disclosure may determine whether the media component satisfies a trigger condition based on a position of the media component. Moreover, the embodiment of the present disclosure may trigger the media component satisfying the trigger condition to play the corresponding media content in response to the media component being played satisfying the switching condition. Therefore, the embodiment of the present disclosure may dynamically switch the preview of the media content in the interface according to the display position of the media component in the display interface of the plurality of media contents, so that the presentation efficiency of the media content is improved.

Various example implementations of this scheme are described in detail below in conjunction with the accompanying drawings.

### Example Environment

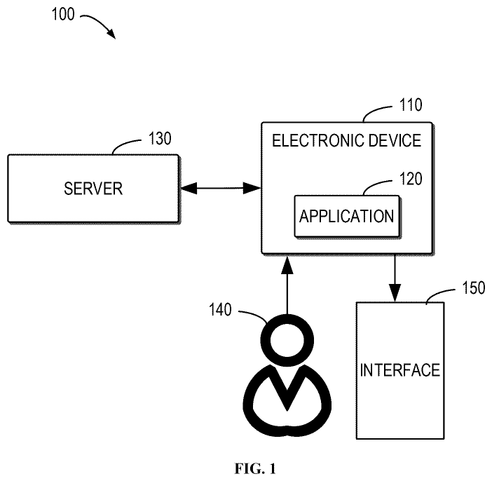

FIG. 1 illustrates a schematic diagram of an example environment 100 in which embodiments of the present disclosure may be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to: a video application, a social application, or other suitable application. A user 140 may interact with the application 120 via the electronic device 110 and/or its attachment device.

In the environment 100 of FIG. 1, if the application 120 is active, the electronic device 110 may present, via the application 120, an interface 150 for supporting interface interaction.

In some embodiments, the electronic device 110 communicates with a server 130 to enable provisioning of services to the application 120. The electronic device 110 may be any type of mobile terminal, fixed terminal, or portable terminal, including mobile phones, desktop computers, laptop computers, notebook computers, netbook computers, tablet computers, media computers, multimedia tablets, personal digital assistants (PDAs), portable game terminals, VR/AR devices, personal communication system (PCS) devices, personal navigation devices, personal digital assistants (PDAs), audio/video players, digital cameras/camcorders, positioning devices, TV receivers, radio broadcast receivers, e-book devices, game devices, or any combination of the foregoing, including accessories and peripherals of these devices or any combination thereof. In some embodiments, the electronic device 110 may also support any type of interface for a user (such as a “wearable” circuit, etc.).

The server 130 may be an independent physical server, a server cluster or a distributed system composed of a plurality of physical servers, or a cloud server that provides basic cloud computing services such as cloud services, cloud databases, cloud computing, cloud functions, cloud storage, network services, cloud communications, middleware services, domain name services, security services, content delivery networks, as well as big data and artificial intelligence platforms. The server 130 may include, for example, computing systems/servers, such as mainframes, edge computing nodes, computing devices in a cloud environment, etc. The server 130 may provide background services for the application 120 that support virtual scenes in the electronic device 110.

A communication connection may be established between the server 130 and the electronic device 110. The communication connection may be established by wired or wireless means. The communication connection may include but is not limited to Bluetooth connection, mobile network connection, Universal Serial Bus (USB) connection, Wireless Fidelity (Wi-Fi) connection, etc. The embodiments of the present disclosure are not limited in this regard. In the embodiments of the present disclosure, the server 130 and the electronic device 110 may achieve signaling interaction through the communication connection between them.

It would be appreciated that the structures and functions of the various elements in the environment 100 are described for example purposes only and do not imply any limitation to the scope of the present disclosure.

Some example embodiments of the present disclosure will be described below with continued reference to the accompanying drawings.

### Interface Interaction

### Example One

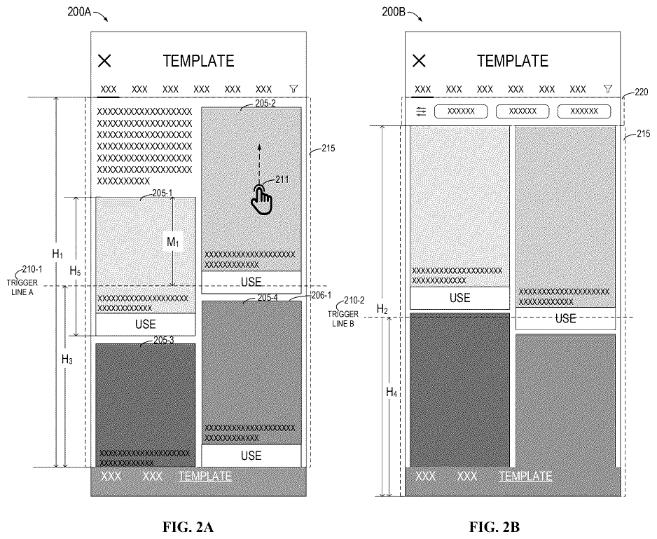

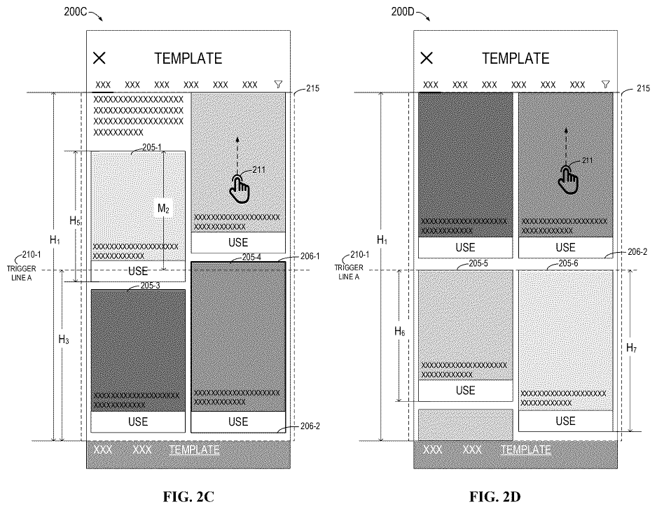

FIGS. 2A-2D illustrate example interfaces 200A-200D according to some embodiments of the present disclosure. The interface 200A to the interface 200D may be provided, for example, by the electronic device 110 shown in FIG. 1.

In some embodiments, as shown in FIG. 2A, the electronic device 110 may present the target interface 200A. The electronic device 110 may present a plurality of media components in the target interface 200A. For example, the plurality of media components may include a media component 205-1, a media component 205-2, a media component 205-3, a media component 205-4, and/or the like. As an example, a media component may be used to play media content. As an example, the media content may include, for example, music content, graphics and text content, video content, template content, and the like. As an example, the target interface 200A may include a double-row information stream media content playing interface. As an example, a plurality of media components may also provide an entry (e.g., “use”) for using template content.

In some embodiments, with continued reference to FIG. 2A, the electronic device 110 may present a plurality of media components in a target style. The target style indicates that at least a portion of the plurality of media components is organized in a plurality of columns or rows.

In some embodiments, with continued reference to FIG. 2A, the electronic device 110 triggers a first media component of the plurality of media components to play a corresponding first media content. As an example, the electronic device 110 may trigger the first media content corresponding to the first media component (e.g., the media component 205-1).

In some embodiments, with continued reference to FIG. 2A, the electronic device 110 may, in response to the target interface 200A being triggered to be presented, the first media component based on a ranking of the plurality of media components in the target interface. As an example, the ranking of the plurality of media components in the target interface may be arranged in a zig-zag order (e.g., in a left-to-right order, in a left-to-right order between rows and rows). For example, the media component 205-1 and the media component 205-2 in a first row may correspond to a first order and a second order, respectively. The media component 205-3 and the media component 205-4 in a second row may correspond to a third order and a fourth order, respectively. As an example, the electronic device 110 may determine a top-ranked media component as the first media component (e.g., the media component 205-1 in the first order) based on the ranking of the plurality of media components in the target interface.

In some embodiments, with continued reference to FIG. 2A, the electronic device 110 may provide a component interaction area 215 (also referred to as a sliding area 215) in the target interface 200A. The electronic device 110 may present a plurality of media components in the component interaction area 215. Further, the electronic device 110 may receive a sliding operation of the user in the component interaction area 215.

As an example, the area size of the component interaction area 215 may include an area height and an area width. The area height may, for example, be referred to as an area length. The area height may be, for example, H1. The area height may indicate a sliding distance limit in a first direction (e.g., the direction indicated by an operation 211). The area width may indicate a sliding distance limit in a direction perpendicular to the first direction.

In some embodiments, with continued reference to FIG. 2A, the electronic device 110 may determine, in response to a change in a layout of the target interface 200A, an updated area size of the component interaction area 215.

In some embodiments, the change in the layout of the target interface 200A may include displaying an additional content area in the target interface 200A.

In some embodiments, as shown in FIG. 2B, the electronic device 110 may determine the updated area size of the component interaction area 215 in response to the additional content area being displayed in the target interface 200B. As an example, the electronic device 110 may determine the updated area size of the component interaction area 215 (e.g., the area height is updated to H2 from H1) in response to a set of filtering components 220 being displayed in the target interface 200B. As an example, displaying the additional content area in the target interface 200B may be triggered based on a user operation (e.g., clicking on a control associated with the additional content area, etc.) , or automatically triggered (e.g., timed display, etc.) in the interface based on a predetermined logic.

In some embodiments, the change in the layout of the target interface 200A may include ceasing display of an existing content area in the target interface 200A.

In some embodiments, with continued reference to FIG. 2A, the electronic device 110 may determine, in response to ceasing display of the existing content area in the target interface 200A, the updated area size of the component interaction area 215. As an example, the electronic device 110 may determine the updated area size of the component interaction area 215 (e.g., the area height is updated from H2 to H1) in response to ceasing to display the set of filtering components 220 in the target interface 200A. As an example, ceasing display of the existing content area in the target interface 200B may be triggered based on a user operation (e.g., clicking on a control associated with an additional content area, etc.), or automatically triggered in the interface based on a predetermined logic (e.g., timed ceasing display, etc.).

As an example, displaying and ceasing display of the aforementioned set of filtering components 220 is merely used as an example description, and the present disclosure is not intended to limit the number, display position, and specific form of the additional content area or the existing content area. For example, different additional content areas are displayed in the target interface 200A at the top and bottom of the component interaction area 215, respectively.

In some embodiments, with continued reference to FIG. 2A, the electronic device 110 may adjust a display position of the plurality of media components in the target interface 200A in response to a predetermined operation (e.g., a sliding operation) for the target interface 200A. As an example, as shown in FIG. 2A, the electronic device 110 may adjust, based on the operation 211 for the target interface 200A, a display position of the plurality of media components in the target interface 200A. As an example, the electronic device 110 may move the plurality of media components in the sliding direction corresponding to the operation 211 based on the sliding distance of the operation 211 to adjust the display position of the plurality of media components in the target interface 200A.

In some embodiments, as shown in FIG. 2C, the electronic device 110 may determine, in response to the at least one media component satisfying a trigger condition, whether the first media component satisfies a switching condition.

As an example, the electronic device 110 may determine that a first display position of the at least one media component satisfies the trigger condition in response to a first boundary of the at least one media component (e.g., the media component 205-4) reaching the predetermined position.

In some embodiments, the first boundary is a boundary of an image area of the at least one media component. As an example, as shown in FIG. 2C, the boundary of the image area of the media component 205-4 may be the area indicated by a bold border in FIG. 2C. It would be noted that the bold border here is only for clear illustrations of the border of the image area, and in actual display, the border display styles of the media component 205-4 and other media components may be the same.

As an example, the first boundary of the at least one media component may be determined based on a sliding direction of the sliding operation. For example, the first boundary corresponds to the sliding direction. As an example, a boundary corresponding to a direction to which the sliding direction points is a first boundary. As an example, a sliding direction corresponding to operation 211 is the first direction. At this instant, the first boundary of the at least one media component (e.g., the media component 205-4) may be a upper boundary 206-1 in the boundary of the image area of the at least one media component.

As an example, the predetermined position may be determined based on a sliding direction of the sliding operation. For example, different sliding directions may correspond to different predetermined positions.

In some embodiments, the predetermined position may be determined based on an area size of a component interaction area in the target interface and/or a component size of the media component. For example, area sizes of different component interaction areas and/or component sizes of media components can correspond to different predetermined positions.

As an example, with continued reference to FIG. 2A or FIG. 2C, the predetermined position may be a height of a trigger line A 210-1. As an example, the area height of the component interaction area 215 is H1, the height of the trigger line A 210-1 is H3, and H3=H1/N. As an example, N may be 2, 2.5, 3, 4, or the like. For example, when N is 2, H3=H1/2, H3 =H1/2 may indicate that the height (e.g., H3) of the trigger line A 210-1 is half of the area height (e.g., H1) of the component interaction area 215.

As an example, with continued reference to FIG. 2B, the predetermined position may be the height of a trigger line B 210-2. As an example, the area height of the component interaction area 215 is H2, the height of the trigger line B 210-2 is H4, and H4=H2/N. As an example, N may be 2, 2.5, 3, 4, or the like. For example, when N is 3, H4=H2/3, H4=H2/3 may indicate that the height (e.g., H4) of the trigger line B 210-2 is one third of the area height (e.g., H2) of the component interaction area 215.

In some embodiments, with continued reference to FIG. 2C, the electronic device 110 may determine, based on a playing duration of the first media component, whether the first media component satisfies the switching condition. For example, the electronic device 110 may determine that the first media component satisfies the switching condition in response to the playing duration of the first media component reaching a predetermined duration (for example, 10 seconds). As an example, the electronic device 110 may determine that the first media component failing to satisfy the switching condition in response to the playing duration of the first media component not reaching the predetermined duration.

Alternatively or in addition, the electronic device 110 may determine whether the first media component satisfies the switching condition based on a movement distance of the first media component after triggering playing. As an example, the electronic device 110 may determine that the first media component satisfies the switching condition in response to a movement distance of the first media component after triggering playing reaching a target distance. For example, the electronic device 110 may determine that the first media component failing to satisfy the switching condition in response to the movement distance of the first media component after triggering playing not reaching the target distance. As an example, the movement distance may be associated with a sliding direction of the sliding operation. As an example, the movement distance may be a distance moved in the sliding direction of the operation 211.

As an example, the target distance may include a predetermined distance. For example, the predetermined distance may be a fixed value (for example, 3 cm).

Alternatively or in addition, the target distance may be determined based on a size of the first media component.

For example, with continued reference to FIG. 2A, the component height of the first media component (e.g., the media component 205-1) is, for example, H5. A moving distance of the first media component is M1. A target distance D may be, for example, D=H5/N. N may be 1, 1.5, 2, 3, and the like. For example, when N is 3,the target distance D=H5/3 (that is, the target distance is one third of the component height of the first media component). For example, if M1<D, it may indicate that the first media component failing to satisfy the switching condition.

For example, with continued reference to FIG. 2C, the movement distance of the first media component (e.g., the media component 205-1) is M2. For example, if M2>D, it may be indicated that the first media component satisfies the switching condition.

In some embodiments, the electronic device 110 may trigger, in response (e.g., at a first instant) to the first media component satisfying the switching condition, a second media component in the at least one media component to play a corresponding second media content. In some embodiments, the second media component is a media component that is in a to-be-played state of the at least one media component. As an example, the second media component is a media component ranked first in in a playing order in the at least one media component. The playing order among the media components in the at least one media component may be determined based on a relative positioning between the at least one media component.

Additionally, the electronic device 110 may determine based on a relative positioning between the at least one media component, a second media component from the at least one media component.

Alternatively or in addition, the at least one media component satisfying the trigger condition may include, for example, a first to-be-played media component and a second to-be-played media component. The electronic device 110 may determine the relative positionings of the first to-be-played media component and the second to-be-played media component. As an example, the relative positioning may indicate a relative positioning of the first to-be-played media component and the second to-be-played media component in a sliding direction (or referred to as a moving direction) and/or a relative positioning perpendicular to the sliding direction. As an example, the relative positioning may be determined based on a boundary position, a center point position, or a predetermined reference line of the first to-be-played media component and the second to-be-played media component.

For example, taking the relative positioning perpendicular to the sliding direction as an example, the at least one media component may include, for example, the media component 205-5 and the media component 205-6. The electronic device 110 may determine that the media component 205-5 and the media component 205-6 are the media component 205-5 on the left side of the media component 205-6 in a direction perpendicular to the sliding direction.

Further, the electronic device 110 may determine the second media component from the at least one media component in response to the relative positioning satisfying the predetermined condition. For example, if the predetermined condition may indicate that the media component whose relative positioning is to the left is the second media component, the electronic device 110 may determine that the media component 205-5 is the second media component in response to the media component 205-5 being on the left side of the media component 205-6.

Alternatively or in addition, taking the relative positioning parallel to the sliding direction as an example, the electronic device 110 may determine, based on a first area size of the first to-be-played media component and a second area size of the second to-be-played media component, a relative positioning of the first to-be-played media component and the second to-be-played media component in the sliding direction (for example, a relative positioning of a center point of the media component). Further, the electronic device 110 may determine, in response to the size of the first area being smaller than the size of the second area, that the first to-be-played media component is in a direction parallel to the sliding direction relative to the second to-be-played media component. Further, the electronic device 110 may determine that the first to-be-played media component is the second media component. For example, the first area size corresponding to the media component 205-5 is H6, and the second area size of the media component 205-6 is H7. The electronic device 110 may determine that the media component 205-5 is the second media component in response to H6<H7.

Alternatively or in addition, the second media component may be determined based on a direction of movement of the target interface. For example, if the moving direction of the target interface is the same direction as the sliding direction corresponding to the operation 211, it may be determined that the predetermined condition indicates preferentially playing the media component on the left in terms of the relative position (for example, the media component 205-5). For example, if the moving direction of the target interface is a direction opposite to the sliding direction corresponding to the operation 211, it may be determined that the predetermined condition indicates preferentially playing the media component on the right in terms of the relative position (e.g., media component 205-6).

In some embodiments, the electronic device 110 may set the at least one media component to a to-be-played state (or to a to-be-played list) in response to the first media component failing to satisfy the switching condition at the first instant. Further, the electronic device 110 may trigger a third media component in the at least one media component to play the corresponding media content in response to determining (e.g., at a second instant) that the first media component satisfies the switching condition.

Alternatively or in addition, the electronic device 110 may determine, in response to the at least one media component (or the to-be-played list) including the plurality of media contents, a target media component that is triggered to be played in the at least one media component (or the to-be-played list) based on an order of adding the plurality of media contents to the at least one media component (or the to-be-played list). Further, the electronic device 110 may trigger the target media component to play the corresponding media content. As an example, the electronic device 110 may trigger the media component in the at least one media component (or the to-be-played list) to play the corresponding media content in response to the switching condition being satisfied at the playing component (e.g., the component that is playing the media content).

As an example, the electronic device 110 may determine the playing order of the plurality of media components in response to the plurality of media components being added to the at least one media component (or the to-be-played list) at the target instant, to trigger the corresponding media component to play the corresponding media content based on the playing order.

For example, the electronic device 110 may determine the playing order of the plurality of media components based on the relative positioning of the plurality of media components. For example, the electronic device 110 triggers the media component whose relative positioning satisfies the predetermined condition to play the corresponding media content. As an example, the predetermined condition may be determined based on a moving direction of the target interface. For example, as shown in FIG. 2D, the electronic device 110 may determine, based on the movement direction being the same as the sliding direction of the operation 211, that the predetermined condition is that the media component with a relatively left relative positioning is played preferentially. The electronic device 110 may determine, based on the movement direction being opposite to the sliding direction of the operation 211, that the predetermined condition is that the media component with a relatively right relative positioning is played preferentially.

Alternatively, the electronic device 110 may determine the playing order of the plurality of media components based on the area sizes of the plurality of media components in the at least one media component (or the to-be-played list). For example, the electronic device 110 may determine a plurality of area sizes corresponding to a plurality of media components in the list to be played. Further, the electronic device 110 may trigger the media component with the smallest size in the plurality of area sizes to play the corresponding media content.

As an example, the electronic device 110 may trigger the second media component to cease playing the second media content corresponding to the second media component in response to the second media component satisfying the switching condition. The switching condition may be determined based on the playing duration, the component size, and/or the moving distance of the second media component, which may be referred to the foregoing description of the switching condition of the first media component.

Alternatively or in addition, as shown in FIG. 2D, the electronic device 110 may further trigger the second media component to cease playing the second media content in response to the second boundary (e.g., a lower boundary 206-2) of the second media component (e.g., the media component 205-4) reaching the predetermined position (e.g., the height of the trigger line A 210-1). As an example, the second boundary (e.g., lower boundary 206-2) is opposite the first boundary (e.g., an upper boundary 206-1).

### Example Two

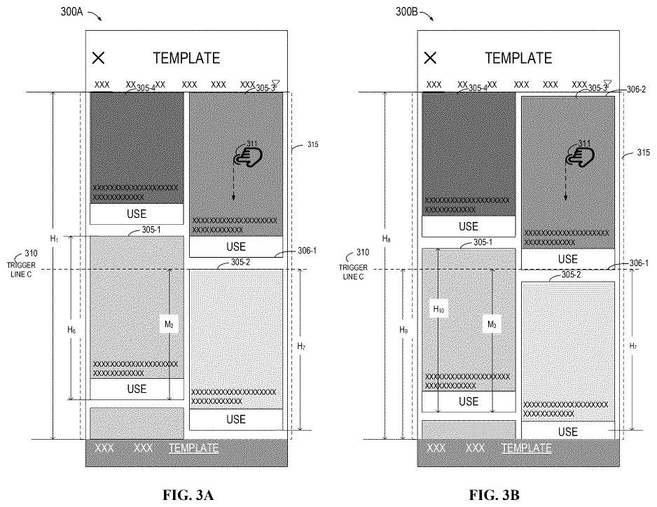

FIGS. 3A-3B illustrate example interfaces 300A-300B according to some embodiments of the present disclosure. The interface 300A to the interface 300B may be provided, for example, by the electronic device 110 shown in FIG. 1.

In some embodiments, as shown in FIG. 3A, the electronic device 110 may present the target interface 300A. The electronic device 110 may present a plurality of media components in the target interface 300A. For example, the plurality of media components may include a media component 305-1, a media component 305-2, a media component 305-3, a media component 305-4, and/or the like. As an example, a media component may be used to play media content.

In some embodiments, the electronic device 110 may present a plurality of media components in a target style. The target style indicates that at least a portion of the plurality of media components is organized in a plurality of columns or rows.

As an example, the media component played by the electronic device 110 at the current instant in the target interface 300A is the first media component. As an example, the electronic device 110 may play (e.g., at a current instant) the first media content corresponding to the first media component (e.g., media component 305-1).

In some embodiments, the electronic device 110 may provide a component interaction area 315 (also referred to as a sliding area 315) in the target interface 300A. The electronic device 110 may present a plurality of media components in the component interaction area 315. Further, the electronic device 110 may receive a sliding operation of the user in the component interaction area 315.

In some embodiments, with continued reference to FIG. 3A, the area size of the component interaction area 315 may include an area height and an area width. The area height may, for example, be referred to as an area length. The area height may be, for example, H8. The area height H8 may indicate a sliding distance limit in a predetermined direction (e.g., parallel to the direction indicated by an operation 311). The area width may indicate a sliding distance limit perpendicular to the predetermined direction.

In some embodiments, with continued reference to FIG. 3A, the electronic device 110 may adjust a display position of the plurality of media components in the target interface 300A in response to a sliding operation for the target interface 300A. As an example, as shown in FIG. 3A, the electronic device 110 may adjust a display position of the plurality of media components in the target interface 300A based on the operation 311 for the target interface 300A. As an example, the electronic device 110 may move the plurality of media components in the sliding direction corresponding to the operation 311 based on the sliding distance of the operation 311 to adjust the display positions of the plurality of media components in the target interface 300A.

In some embodiments, as shown in FIG. 3B, the electronic device 110 may determine whether the first media component satisfies the switching condition in response to the display position of the at least one media component being updated to satisfy the trigger condition.

As an example, the electronic device 110 may determine that the display position of the at least one media component satisfies the trigger condition in response to the first boundary of the at least one media component (e.g., the media component 305-3) reaching the predetermined position.

As an example, the first boundary of the at least one media component may be determined based on a sliding direction of the sliding operation. For example, the first boundary corresponds to the sliding direction. As an example, a boundary corresponding to a direction to which the sliding direction points is a first boundary. As an example, the sliding direction corresponding to the operation 311 is the second direction. At this instant, the first boundary of the at least one media component (e.g., the media component 305-3) may be a lower boundary 306-1 in the boundary of the image area of the at least one media component.

As an example, the predetermined position may be determined based on a sliding direction of the sliding operation. For example, different sliding directions may correspond to different predetermined positions.

In some embodiments, the predetermined position may be determined based on an area size of a component interaction area in the target interface and/or a component size of the media component. For example, different component interaction areas may correspond to different predetermined positions.

As an example, with continued reference to FIG. 3A or FIG. 3B, the predetermined position may be a height of the trigger line C 310S. As an example, the area height of the component interaction area 315 is H8, the height of the trigger line C 310 is H9, and H9=H8/N. As an example, N may be 2, 2.5, 3, 4, or the like. For example, when N is 2, H9=H8/2, H9=H8/2 may indicate that a height (for example, H9) of the trigger line C 310 is half of an area height (for example, H8) of the component interaction area 315.

In some embodiments, with continued reference to FIG. 3A, the electronic device 110 may determine, based on the playing duration of the first media component, whether the first media component satisfies the switching condition. For example, the electronic device 110 may determine that the first media component satisfies the switching condition in response to the playing duration of the first media component reaching the predetermined duration (for example, 10 seconds). As an example, the electronic device 110 may determine that the first media component failing to satisfy the switching condition in response to the playing duration of the first media component not reaching the predetermined duration.

Alternatively or in addition, the electronic device 110 may determine whether the first media component satisfies the switching condition based on the movement distance of the first media component after triggering playing. As an example, the electronic device 110 may determine that the first media component satisfies the switching condition in response to the movement distance of the first media component after triggering playing reaching the target distance. For example, the electronic device 110 may determine that the first media component failing to satisfy the switching condition in response to the movement distance of the first media component after triggering playing failing to reach the target distance. As an example, the movement distance may be associated with a sliding direction of the sliding operation. As an example, the movement distance may be a distance moved in the sliding direction of operation 211.

As an example, the target distance may include a predetermined distance. For example, the predetermined distance may be a fixed value (for example, 4 cm).

Alternatively or in addition, the target distance may be determined based on a size of the first media component.

For example, with continued reference to FIG. 3A, the component height of the first media component (e.g., the media component 305-1) is, for example, H10. The moving distance of the first media component is M3. The target distance D may be, for example, D=H10/N. N may be 1, 1.5, 2, 3, and the like. For example, when N is 3, the target distance D=H10/23 (that is, the target distance is one third of the component height of the first media component). For example, if M3<D, it may indicate that the first media component failing to satisfy the switching condition.

For example, with continued reference to FIG. 3B, the movement distance of the first media component (e.g., media component 305-1) is M4. For example, if M4>D, it may be indicated that the first media component satisfies the switching condition.

In some embodiments, the electronic device 110 may trigger the second media component (e.g., the media component 305-3) determined from the at least one media component to play the corresponding second media content in response to determining that the first media component satisfies the switching condition. As an example, the second media component is a media component ranked first in the in the playing order in the at least one media component. The playing order among the media components in the at least one media component may be determined based on the relative positioning between the at least one media component.

As an example, the electronic device 110 may trigger the second media component to cease playing the second media content corresponding to the second media component in response to the second media component satisfying the switching condition. The switching condition may be determined based on the playing duration, the component size, and/or the moving distance of the second media component, which may be referred to the foregoing description of the switching condition of the first media component.

Alternatively or in addition, the electronic device 110 may also trigger the second media component to cease playing the second media content in response to the second boundary (e.g., the upper boundary 306-2) of the second media component (e.g., the media component 305-3) reaching the predetermined position (e.g., the height of the trigger line C 310). As an example, the second boundary (e.g., the upper boundary 306-2) is opposite the first boundary (e.g., the lower boundary 306-1).

Based on the processes described above, the embodiments of the present disclosure may determine or adjust different predetermined positions for triggering a media components to play a media content based on a component interaction area, a media component, and a further component in the target interface, and based on different sliding directions. Moreover, the embodiments of the present disclosure may adjust the position of the media component based on the sliding operation of the user, and may determine whether the media component satisfies the trigger condition according to the position of the media component. In addition, the embodiments of the present disclosure may determine whether to trigger the media component satisfying the trigger condition to play the corresponding media content based on whether the playing component satisfies the switching condition. In this way, the embodiments of the present disclosure may dynamically switch the preview of the media content in the interface according to the display position and the sliding direction of the media component in the display interface of the plurality of media contents, thereby improving the presentation efficiency of the media content.

### Example Process

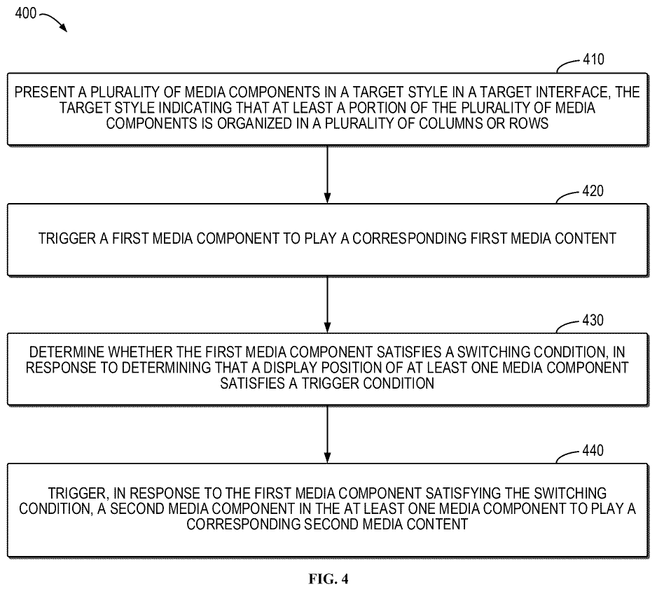

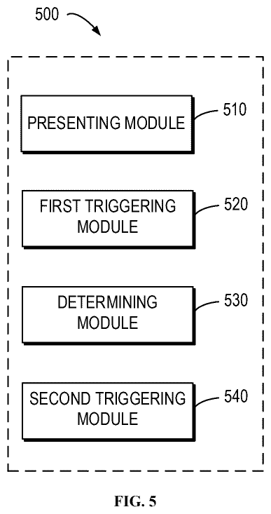

FIG. 4 illustrates a flowchart of an example process 400 of interface interaction according to some embodiments of the present disclosure. The process 400 may be implemented at the electronic device 110. The process 400 is described below with reference to FIG. 1.

As shown, at block 410, the electronic device 110 presents a plurality of media components in a target style in a target interface, the target style indicating that at least a portion of the plurality of media components is organized in a plurality of columns or rows.

At block 420, the electronic device 110 triggers a first media component to play a corresponding first media content.

At block 430, the electronic device 110 determines whether the first media component satisfies a switching condition, in response to determining that a display position of at least one media component satisfies a trigger condition.

At block 440, the electronic device 110 triggers, in response to the first media component satisfying the switching condition, a second media component in the at least one media component to play a corresponding second media content.

In some embodiments, the process 400 further includes: setting the at least one media component to a to-be-played state in response to the first media component failing to satisfy the switching condition.

In some embodiments, the second media component is a media component that is in a to-be-played state of the at least one media component.

In some embodiments, the process 400 further includes: determining, based on a relative positioning between the at least one media component, a second media component from the at least one media component.

In some embodiments, the second media component is determined further based on a direction of movement of the target interface.

In some embodiments, the trigger condition includes: that a first boundary of the at least one media component reaches a predetermined position, wherein the first boundary is determined based on a sliding direction of a sliding operation.

In some embodiments, the predetermined position is determined based on an area size of a component interaction area in the target interface and/or a component size of a media component.

In some embodiments, the process 400 further includes: determining, in response to a change in a layout of the target interface, an updated area size of the component interaction area; and adjusting the predetermined position based on the updated area size.

In some embodiments, the change of the layout of the target interface includes: displaying an additional content area in the target interface; and/or ceasing display of an existing content area in the target interface.

In some embodiments, the process 400 further includes: triggering the second media component to cease playing the second media content, in response to a second boundary of the second media component reaching the predetermined position, wherein the second boundary is opposite to the first boundary.

In some embodiments, the first boundary and/or the second boundary are boundaries of an image area of the second media component.

In some embodiments, determining whether the first media component satisfies the switching condition includes: determining that the first media component satisfies the switching condition in response to a playing duration of the first media component reaching a predetermined duration; or determining that the first media component satisfies the switching condition in response to a movement distance of the first media component after triggering playing reaching a target distance.

In some embodiments, the target distance comprises a predetermined distance; or the target distance is determined based on a size of the first media component.

In some embodiments, triggering the first media component to play the corresponding first media content includes: determining, in response to the target interface being triggered to be presented, the first media component based on a ranking of the plurality of media components in the target interface to trigger the first media component to play the first media content.

### Example Apparatus and Device

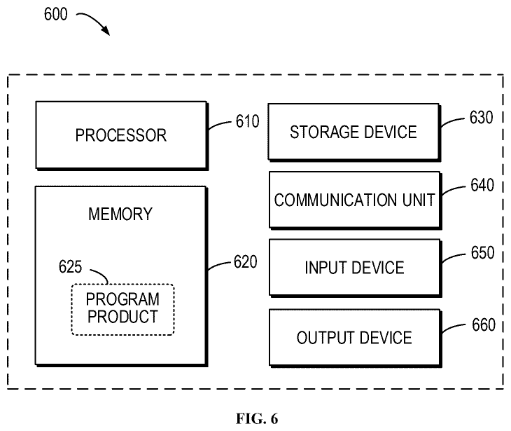

Embodiments of the present disclosure also provide a corresponding apparatus for implementing the above method or process. FIG. 5 shows a schematic structural block diagram of an example apparatus 500 for interface interaction according to some embodiments of the present disclosure. The apparatus 500 may be implemented or included in the electronic device 110. The various modules/components in the apparatus 500 may be implemented by hardware, software, firmware, or any combination thereof.

As shown in FIG. 5, the apparatus 500 includes a presenting module 510 configured to present a plurality of media components in a target style in a target interface, the target style indicating that at least a portion of the plurality of media components is organized in a plurality of columns or rows; a first triggering module 520 configured to trigger a first media component to play a corresponding first media content; a determining module 530 configured to determine whether the first media component satisfies a switching condition, in response to determining that a display position of at least one media component satisfies a trigger condition; and a second triggering module 540 configured to trigger, in response to the first media component satisfying the switching condition, a second media component in the at least one media component to play a corresponding second media content.

In some embodiments, the apparatus 500 further includes a state module configured to set the at least one media component to a to-be-played state in response to the first media component failing to satisfy the switching condition.

In some embodiments, the second media component is a media component that is in a to-be-played state of the at least one media component.

In some embodiments, the apparatus 500 further includes a position determining module configured to determine, based on a relative positioning between the at least one media component, a second media component from the at least one media component.

In some embodiments, the second media component is determined further based on a direction of movement of the target interface. In some embodiments, the trigger condition includes: that a first boundary of the at least one media component reaches a predetermined position, wherein the first boundary is determined based on a sliding direction of a sliding operation.

In some embodiments, the predetermined position is determined based on an area size of a component interaction area in the target interface and/or a component size of a media component.

In some embodiments, the apparatus 500 further includes an updating module configured to: determine, in response to a change in a layout of the target interface, an updated area size of the component interaction area; and adjust the predetermined position based on the updated area size.

In some embodiments, the change of the layout of the target interface includes: displaying an additional content area in the target interface; and/or ceasing display of an existing content area in the target interface.

In some embodiments, the apparatus 500 further includes a ceasing module configured to trigger the second media component to cease playing the second media content, in response to a second boundary of the second media component reaching the predetermined position, wherein the second boundary is opposite to the first boundary.

In some embodiments, the first boundary and/or the second boundary are boundaries of an image area of the second media component.

In some embodiments, the determining module 530 is further configured to: determine that the first media component satisfies the switching condition in response to a playing duration of the first media component reaching a predetermined duration; or determine that the first media component satisfies the switching condition in response to a movement distance of the first media component after triggering playing reaching a target distance.

In some embodiments, the target distance comprises a predetermined distance; or the target distance is determined based on a size of the first media component.

In some embodiments, the first triggering module 520 is further configured to: determine, in response to the target interface being triggered to be presented, the first media component based on a ranking of the plurality of media components in the target interface to trigger the first media component to play the first media content.

FIG. 6 illustrates a block diagram of an electronic device 600 in which one or more embodiments of the present disclosure may be implemented. It would be understood that the electronic device 600 illustrated in FIG. 6 is merely for example and would not constitute any limitation on the function and scope of the embodiments described herein. The electronic device 600 shown in FIG. 6 can be used as an electronic device.

As shown in FIG. 6, the electronic device 600 is in a form of a general-purpose electronic device. Components of the electronic device 600 may include, but are not limited to, one or more processors or processing unit 610, memory 620, storage device 630, one or more communication units 640, one or more input devices 650, and one or more output devices 660. The processor 610 may be actual or virtual processors and are capable of performing various processes based on programs stored in the memory 620. In a multiprocessor system, a plurality of processor performs computer-executable instructions in parallel to increase the parallel processing power of the electronic device 600.

The electronic device 600 typically includes a plurality of computer storage media. Such media may be any obtainable media accessible to the electronic device 600, including, but not limited to, volatile and non-volatile media, removable and non-removable media. The memory 620 may be volatile memory (e.g., registers, cache, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium, such as a flash drive, a disk, or any other medium that may be capable of being configured to store information and/or data and may be accessible within the electronic device 600.

The electronic device 600 may further include additional removable/non-removable, volatile/non-volatile storage media. Although not shown in FIG. 6, a disk drive for reading from or writing to a removable, non-volatile disk (e.g., a ‘floppy disk’) and an optical disk drive for reading from or writing to a removable, non-volatile optical disk may be provided. In these embodiments, each drive may be connected to a bus (not shown) by one or more data media interfaces. The memory 620 may include a computer program product 625 having one or more program modules that are configured to perform various methods or actions of various embodiments of the present disclosure.

The communication unit 640 implements communication with other electronic devices via a communication medium. Additionally, the functions of the components of the electronic device 600 may be implemented as a single computing cluster or a plurality of computing machines that are capable of communicating over a communication connection. Thus, the electronic device 600 may use logical connections to one or more other servers, networked personal computers (PCs), or another network node to operate in a networked environment.

The input device 650 may be one or more input devices, such as a mouse, a keyboard, a tracking ball, and the like. The output device 660 may be one or more output devices, such as a monitor, a speaker, a printer, and the like. The electronic device 600 may also communicate, as desired, via the communication unit 640, with one or more external devices (not shown), external devices such as storage devices, display devices, etc., with one or more devices that enable a user to interact with the electronic device 600, or with any device that enables the electronic device 600 to communicate with one or more other electronic devices (e.g., a network card, modem, etc.) to communicate. Such communication may be performed via an input/output (I/O) interface (not shown).

According to an example implementation of the present disclosure, there is provided a computer-readable storage medium having computer-executable instructions stored thereon, wherein the computer-executable instructions are performed by a processor to implement the method described above. According to an example implementation of the present disclosure, there is also provided a computer program product, the computer program product being tangibly stored on a non-transient computer-readable medium and including computer-executable instructions, wherein the computer-executable instructions are performed by a processor to implement the methods described above.

Aspects of the present disclosure are described herein with reference to flowcharts and/or block diagrams of methods, apparatuses, devices, and computer program products implemented according to the present disclosure. It would be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, function, and operation of possible implementations of systems, methods, and computer program products according to various implementations of the present disclosure. In this regard, each block in the flowchart or block diagram may represent a module, program segment, or part of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations would be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method for interface interaction, comprising:
presenting a plurality of media components in a target style in a target interface, the target style indicating that at least a portion of the plurality of media components is organized in a plurality of columns or rows;
triggering a first media component to play a corresponding first media content;
determining whether the first media component satisfies a switching condition, in response to determining that a display position of at least one media component satisfies a trigger condition; and
triggering, in response to the first media component satisfying the switching condition, a second media component in the at least one media component to play a corresponding second media content.

2. The method of claim 1, further comprising:
setting the at least one media component to a to-be-played state in response to the first media component failing to satisfy the switching condition.

3. The method of claim 1, wherein the second media component is a media component that is in a to-be-played state of the at least one media component.

4. The method of claim 1, further comprising:
determining, based on a relative positioning between the at least one media component, a second media component from the at least one media component.

5. The method of claim 4, wherein the second media component is determined further based on a direction of movement of the target interface.

6. The method of claim 1, wherein the trigger condition comprises:
that a first boundary of the at least one media component reaches a predetermined position, wherein the first boundary is determined based on a sliding direction of a sliding operation.

7. The method of claim 6, wherein the predetermined position is determined based on an area size of a component interaction area in the target interface and/or a component size of a media component.

8. The method of claim 7, further comprising:
determining, in response to a change in a layout of the target interface, an updated area size of the component interaction area; and
adjusting the predetermined position based on the updated area size.

9. The method of claim 8, wherein the change in the layout of the target interface comprises:
displaying an additional content area in the target interface; and/or
ceasing display of an existing content area in the target interface.

10. The method of claim 6, further comprising:
triggering the second media component to cease playing the second media content, in response to a second boundary of the second media component reaching the predetermined position, wherein the second boundary is opposite to the first boundary.

11. The method of claim 10, wherein the first boundary and/or the second boundary are boundaries of an image area of the second media component.

12. The method of claim 1, wherein determining whether the first media component satisfies the switching condition comprises:
determining that the first media component satisfies the switching condition in response to a playing duration of the first media component reaching a predetermined duration, or
determining that the first media component satisfies the switching condition in response to a movement distance of the first media component after triggering playing reaching a target distance.

13. The method of claim 12, wherein:
the target distance comprises a predetermined distance; or
the target distance is determined based on a size of the first media component.

14. The method of claim 1, wherein triggering the first media component to play the corresponding first media content comprises:
determining, in response to the target interface being triggered to be presented, the first media component based on a ranking of the plurality of media components in the target interface and triggering the first media component to play the first media content.

15. An electronic device, comprising:
at least one processor; and
at least one memory coupled to the at least one processor and storing instructions for execution by the at least one processor, the instructions, when executed by the at least one processor, causing the electronic device to perform acts comprising:
presenting a plurality of media components in a target style in a target interface, the target style indicating that at least a portion of the plurality of media components is organized in a plurality of columns or rows;
triggering a first media component to play a corresponding first media content;
determining whether the first media component satisfies a switching condition, in response to determining that a display position of at least one media component satisfies a trigger condition; and
triggering, in response to the first media component satisfying the switching condition, a second media component in the at least one media component to play a corresponding second media content.

16. The electronic device of claim 15, wherein the acts further comprise:
setting the at least one media component to a to-be-played state in response to the first media component failing to satisfy the switching condition.

17. The electronic device of claim 15, wherein the second media component is a media component that is in a to-be-played state of the at least one media component.

18. The electronic device of claim 15, wherein the acts further comprise:
determining, based on a relative positioning between the at least one media component, a second media component from the at least one media component.

19. The electronic device of claim 18, wherein the second media component is determined further based on a direction of movement of the target interface.

20. A non-transitory computer-readable storage medium having a computer program stored thereon, the computer program being executable by a processor to perform acts comprising:
presenting a plurality of media components in a target style in a target interface, the target style indicating that at least a portion of the plurality of media components is organized in a plurality of columns or rows;
triggering a first media component to play a corresponding first media content;
determining whether the first media component satisfies a switching condition, in response to determining that a display position of at least one media component satisfies a trigger condition; and
triggering, in response to the first media component satisfying the switching condition, a second media component in the at least one media component to play a corresponding second media content.
